(19) United States
(12) Patent Application Publication
(10) Pub. No.: US 2016/0171819 A1
(43) Pub. Date: Jun. 16, 2016

(54) GAMING APPARATUS AND ASSOCIATED METHOD

(71) Applicant: Paltronics Australasia Pty Limited, Taren Point (AU)

(72) Inventors: Dean Wright, Taren Point (AU); Stephen Cowan, Taren Point (AU)

(21) Appl. No.: 14/971,909

(22) Filed: Dec. 16, 2015

(30) Foreign Application Priority Data
Dec. 16, 2014 (AU) 2014905085

(51) Int. Cl. G07F 17/32; G07F 17/34

(52) U.S. Cl. CPC G07F 17/3213; G07F 17/34

(57) ABSTRACT

The invention provides a gaming apparatus including a first electronic gaming machine EGM 1 communicatively interlinked to a second EGM 2. The first and second EGM's are each configured so as to store respective credit values. The first EGM 1 has a player operable input module 7 for causing the first EGM 1 to send a credit transfer proposal message to the second EGM 2. The second EGM 2 is responsive to receipt of the credit transfer proposal message so as to provide a player of the second EGM 2 with an option to accept or decline the proposal. The first and second EGM's are responsive to an acceptance of the proposal so as to transfer credit from the first EGM 1 to the second EGM 2. As best shown in FIG. 4, the second EGM 2 is operable at step S17 so as to execute gaming activity using transferred credit Cₜ and, if said gaming activity generates a player benefit, a first proportion of the benefit is allocated to the first EGM 1 at step S19 and a second proportion of the benefit is allocated to the second EGM 2 at step S18.

### FIELD OF THE INVENTION

The present invention relates to gaming methods and associated apparatus. Embodiments of the present invention find application, though not exclusively, in the gaming industry for use in the context of linked networks of electronic gaming machines, such as slot machines for example. Embodiments of the present invention are typically deployed in establishments that provide gaming facilities, such as casinos, pubs, clubs and the like.

### BACKGROUND OF THE INVENTION

It is known to link a number of electronic gaming machines to form a network. Some embodiments of such networks may include a central controller configured to provide secondary gaming, such as jackpot games and the like in which each of the linked electronic gaming machines may participate. This secondary gaming is typically provided in addition to the primary game provided by each of the electronic gaming machines, which may for example be slots, poker, blackjack, bingo, keno, or the like.

It has been appreciated by the inventors of the present invention that it would be advantageous to extend the functionality of such gaming machines so as to provide players with new and interesting options and experiences.

Any discussion of documents, acts, materials, devices, articles or the like which has been included in this specification is solely for the purpose of providing a context for the present invention. It is not to be taken as an admission that any or all of these matters form part of the prior art base or were common general knowledge in the field relevant to the present invention as it existed in Australia or elsewhere before the priority date of this application.

### SUMMARY OF THE INVENTION

It is an object of the present invention to overcome, or substantially ameliorate, one or more of the disadvantages of the prior art, or to provide a useful alternative.

In one aspect of the present invention there is provided a gaming apparatus including:

a first electronic gaming machine (EGM) communicatively interlinked to a second EGM;

the first and second EGM's each being configured so as to store respective credit values;

the first EGM having a player operable input module for causing the first EGM to send a credit transfer proposal message to the second EGM;

the second EGM being responsive to receipt of the credit transfer proposal message so as to provide a player of the second EGM with an option to accept or decline the proposal;

the first and second EGM's being responsive to an acceptance of the proposal so as to transfer credit from the first EGM to the second EGM; and

the second EGM being operable so as to execute gaming activity using transferred credit and, if said gaming activity generates a player benefit, a first proportion of the benefit is allocated to the first EGM and a second proportion of the benefit is allocated to the second EGM.

In one embodiment the gaming activity is the placement of a wager using said transferred credit, the generation of a game outcome and the determination of a prize amount in dependence upon the game outcome and the benefit is the prize amount. In another embodiment, or additionally, the benefit may be, or include, a points award.

Preferably the credit transfer proposal message defines an amount of credit that is proposed to be transferred.

In an embodiment the second EGM is configured so as to store a native credit value and a transferred credit value. For this embodiment the second EGM is configured to provide the player of the second EGM with an option to place a wager using either native credit or transferred credit.

In an embodiment the first proportion is between 10% and 50%. In another embodiment the first EGM is configured to receive an input from the player operable input module so as to allow a player of the first EGM to define the first proportion. In this embodiment the credit transfer proposal message includes an amount of credit that is proposed to be transferred and the message also includes the first proportion and the provision to the player of the second EGM of an option to accept or decline the proposal includes advising the player of the second EGM of an amount of credit that is proposed to be transferred and advising the player of the second EGM of the first proportion.

In one embodiment, if a player of the first EGM cashes out of the first EGM at a time when a remaining amount of transferred credit is being stored by the second EGM, then the remaining amount of transferred credit is transferred back to the first EGM and cashed out to the player of the first EGM.

In another embodiment the first EGM is adapted to receive an identifier of a player of the first EGM and to access information stored within an account associated with the player of the first EGM. In this embodiment, if a player of the first EGM cashes out of the first EGM at a time when a remaining amount of transferred credit is being stored by the second EGM, then the remaining amount of transferred credit remains on the second EGM and the first proportion of any further benefits derived from gaming activity on the second EGM using the remaining amount of transferred credit is allocated to the account associated with the player of the first EGM.

In an embodiment, if a player of the second EGM cashes out of the second EGM at a time when a remaining amount of transferred credit is being stored by the second EGM, and whilst the player of the first EGM is still playing the first EGM, then the remaining amount of transferred credit is transferred back to the first EGM.

In another embodiment, if a player of the second EGM cashes out of the second EGM at a time when a remaining amount of transferred credit is being stored by the second EGM, and after the player of the first EGM has cashed out of the first EGM, then the remaining amount of transferred credit is allocated to the account associated with the player of the first EGM.

Optionally, a house commission may be charged when credits are transferred from one EGM to another.

In another embodiment a plurality of EGM's are communicatively interconnected and the player operable input module of the first EGM is operable to cause the first EGM to send credit transfer proposal messages to some or all of the other EGM's within said plurality of EGM's.

Preferably the first and second EGM's each have display screens and, whilst the second EGM is executing said gaming activity using transferred credit, an image corresponding to an image on the display screen of the second EGM is depicted on the display screen of the first EGM.

According to another aspect of the invention there is provided a gaming method implementable on a first electronic gaming machine (EGM) communicatively interlinked to a second EGM, the method including:

storing credit values in each of the first and second EGM's;

being responsive to a player input on the first EGM so as to send a credit transfer proposal message from the first EGM to the second EGM;

being responsive to receipt of the credit transfer proposal message so as to provide a player of the second EGM with an option to accept or decline the proposal;

being responsive to an acceptance of the proposal so as to transfer credit from the first EGM to the second EGM; and

executing gaming activity on the second EGM using transferred credit and, if said gaming activity generates a player benefit, allocating a first proportion of the benefit to the first EGM and allocating a second proportion of the benefit to the second EGM.

In one embodiment the first EGM is communicatively interlinked to the second EGM via a central controller.

The features and advantages of the present invention will become further apparent from the following detailed description of preferred embodiments, provided by way of example only, together with the accompanying drawings.

### BRIEF DESCRIPTION OF THE ACCOMPANYING DRAWINGS

FIG. 1 is a schematic representation of a first embodiment of the present invention;

FIG. 2 is a schematic representation of a second embodiment of the present invention;

FIG. 3 is a flowchart showing steps performed in an embodiment of the inventive method; and

FIG. 4 is another flowchart showing steps performed in an embodiment of the inventive method.

### DETAILED DESCRIPTION OF PREFERRED EMBODIMENTS OF THE INVENTION

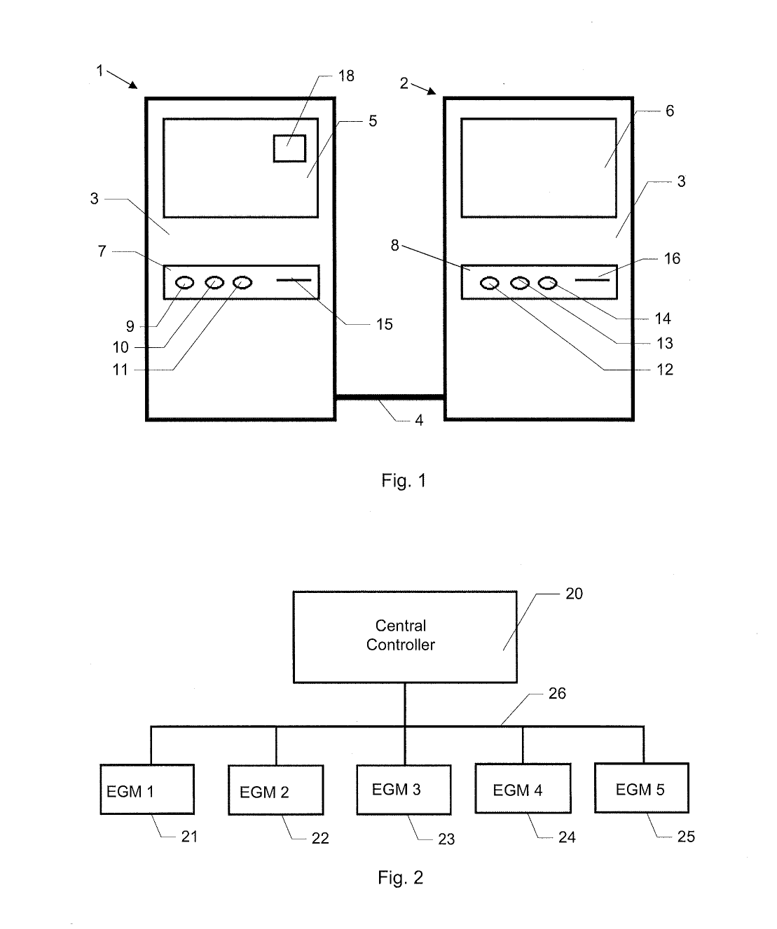

Referring to FIG. 1, the gaming apparatus includes a first electronic gaming machine 1 (EGM 1) communicatively interlinked to a second electronic gaming machine 2 (EGM 2). These may be any type of EGM, for example slot machines, poker machines, blackjack machines, bingo machines, keno machines, or the like. As illustrated in FIG. 1, both of the EGM's 1 and 2 are purpose built gaming machines housed within free standing cabinets 3. However in alternative embodiments, one or both of the EGM's 1 and 2 take the form of other devices, such as hand held mobile phones, desktop computers, laptop computers, tablets, kiosks etc. The communicative link is provided by networking cable 4, which allows data signals to travel between the two EGM's, although other embodiments make use of alternative linking means, such as a wireless connection, and so forth.

Each of the EGM's 1 and 2 has a processor and associated memory in the form of RAM, ROM and media reader/writers. The processor of each EGM 1 and 2 executes gaming software, which configures the EGM's to provide one or more games. This also configures the RAM so as to store respective credit values for each of the EGM's 1 and 2.

The EGM's 1 and 2 each have a display screen 5 and 6. Additionally, each of the EGM's 1 and 2 has a player input module 7 and 8, which provides buttons 9, 10 and 11 on EGM 1 and buttons 12, 13 and 14 on EGM 2. It will be appreciated, however, that other input devices and hardware may be provided in alternative embodiments. For example, in some embodiments the display screens 5 and 6 are touch sensitive.

EGM 1 has slot 15 and EGM 2 has slot 16. This allows players the option of inserting an identifier, such as a card bearing magnetically encoded information, by which the players may identify themselves to the EGM that they are using so as to participate in the options provided by a player tracking system. The information stored in the player tracking system may be stored locally on one or both of the EGM's, or it may be stored on a controller 20 that is communicatively connected to the EGM's, as shown in FIG. 2.

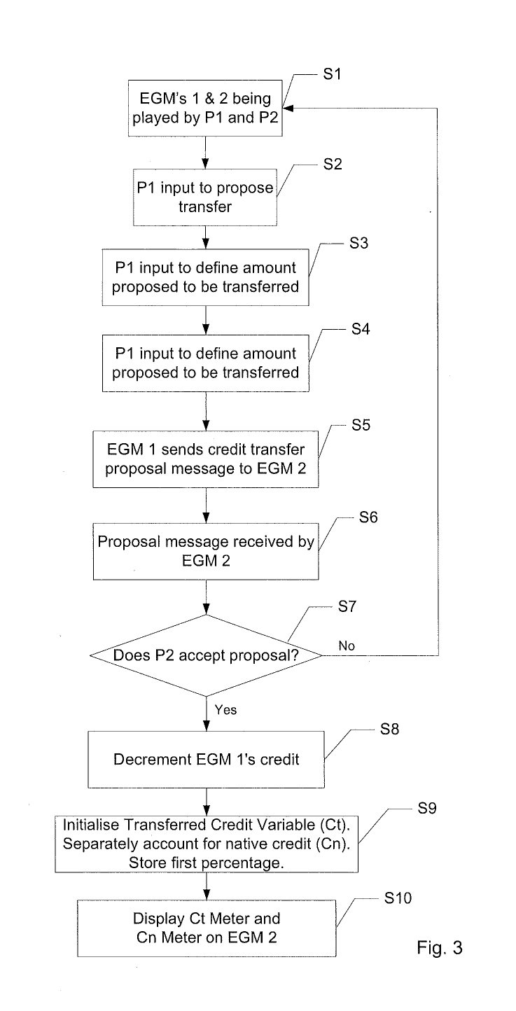

A flowchart of an embodiment of the gaming method is shown in FIG. 3. At step S1, a person is playing EGM 1 and another person is playing EGM 2. For the sake of a running example, we shall assume that the credit being stored in the RAM of EGM 1 has a value of 200 credits and the credit being stored in the RAM of EGM 2 has a value of 10 credits. At step S2 the player of EGM 1 (hereinafter referred to as “P1”) presses button 9 so as to indicate to the processor of EGM 1 that he or she wishes to propose to transfer some of his or her credit to EGM 2. P1 may choose to do this for a number of reasons. For example, the player of EGM 2 (hereinafter referred to as “P2”) may be a friend of P1's and hence P1 may be happy to fund further gaming by P2 so that P1 can continue to enjoy P2's comradery. Alternatively, P1 may be aware that EGM 2 has a potential to award a large jackpot and for this reason P1 may wish to transfer some credit from EGM 1 to EGM 2 to gain an opportunity to potentially share in any jackpot winnings. Another potential motivator for P1 may be that P1 perceives that EGM 2 is ‘running hot’. In other words, P1 may perceive that EGM 2 is in a state that is likely to generate substantial winnings and hence P1 may wish to transfer some credit from EGM 1 to EGM 2 to gain an opportunity to potentially share in those winnings.

The processor of EGM 1 is responsive to the pressing of button 9 so as to execute a routine that allows P1 to make a further input at step S3 to define the amount of credit that P1 proposes to transfer. The processor of EGM 1 causes the display screen 5 to display this message to P1: “Press button 9 to propose to transfer an amount of 50 credits to EGM 2. Press button 10 to propose to transfer an amount of 100 credits to EGM 2. Press button 11 to propose to transfer an amount of 150 credits to EGM 2.” For the sake of the running example, we shall assume that P1 presses button 9. In response to the pressing of button 9 the processor of EGM 1 initialises a variable in the RAM representing the proposed amount of transferred credit to 50 credits.

At step S4, P1 makes a further input via buttons 9, 10 and 11 to define the first proportion. More specifically, the ‘first proportion’ is the proportion that will be allocated back to EGM 1 of any benefit arising from gaming activity on EGM 2 that is funded by credit transferred from EGM 1. The processor of EGM 1 causes the display screen 5 to display this message to P1: “Press button 9 to propose a 10% return. Press button 10 to propose a 35% return. Press button 11 to propose a 50% return.” For the sake of the running•example, we shall assume that P1 presses button 10, in response to which, the processor of EGM 1 initialises a variable in the RAM representing the first proportion to 35%.

At step S5 the processor of EGM 1 sends a credit transfer proposal message from the first EGM to the second EGM via communications cable 4. The processor of EGM 1 accesses the previously stored values for the amount of credit that is proposed to be transferred (i.e. 50 credits in the running example) and the first proportion (i.e. 35% in the running example) and includes these values in the message.

At step S6 the credit transfer proposal message is received and parsed by EGM 2. In response to receipt of the message, at step S7 the processor of EGM 2 causes the display screen 6 to display a message to P2 that includes the amount of credit that is proposed to be transferred, along with the second proportion. In the running example the message reads: “EGM 1 is proposing to transfer 50 credits to you. 35% of the benefit arising from these winnings will be allocated to EGM 1. If you wish to accept this proposal, press button 12. If you wish to decline this proposal, press button 13.” Providing P2 with an option to accept or decline the credit transfer inhibits P1 from effectively ‘forcing’ his or her credits onto P2's EGM. Additionally, advising P2 of the value of the first proportion informs P2's decision as to whether to accept or decline the transfer. If P2 presses button 13, the process flow returns to step S1 and P1 and P2 continue their gaming activities with their respective credit values being unchanged. However, if P2 presses button 12, the process flow proceeds to step S8 at which the processor of EGM 1 decrements the variable representing EGM 1's current credit by the amount being transferred. Hence, in the running example, the new current credit amount on EGM 1 is 200−50=150 credits. P1 is now free to continue his or her gaming activity in the ordinary manner with the 150 credits that remain on EGM 1.

At step S9 the processor of EGM 2 initialises a new variable, Ct, in the RAM representing transferred credit to a value of 50 credits. The amount of native credit, Cn, (i.e. 10 credits), is allowed to remain stored unchanged within the RAM of EGM 2. Additionally, the value of the first proportion, which in the running example is 35%, is stored within the RAM of EGM 2.

At step S10 the processor of EGM causes the display screen 6 to display two credit meters. In the running example the native credit meter shows 10 credits and the transferred credit meter shows 50 credits.

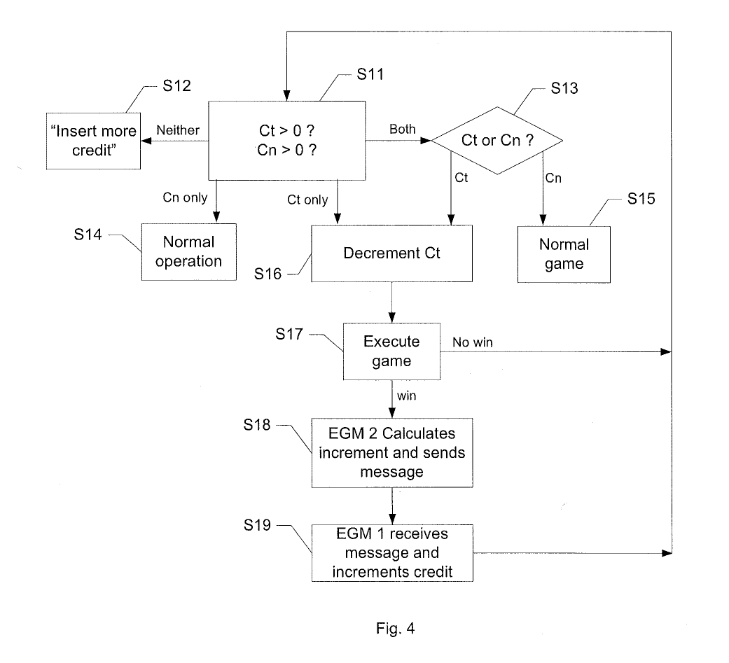

The process flow now proceeds to the flowchart shown in FIG. 4. At step S11 the processor of EGM 2 determines if neither, one or the other, or both, of the variables representing transferred credit (Ct) and the native credit (Cn) are positive non-zero values. If neither are positive non-zero values, then P2 has run out of credit and the process flow proceeds to S12 at which the processor of EGM 2 causes the screen 6 to display a message prompting P2 to insert more credit. If both are positive non-zero values (as per the running example) the process flow proceeds to step S13, which will be described below. If only the variable representing the native credit is a positive non-zero value, (in other words, if all of the transferred credit has been spent) then the process flow proceeds to step S14 at which the EGM 2 reverts to normal operation whereby none of the benefit arising from further games executed by EGM 2 will be allocated to EGM 1. If only the variable representing the transferred credit is a positive non-zero value, (in other words, if all of the native credit has been spent) then the process flow proceeds to step S16, which will be described below.

At step S13, the processor of EGM 2 provides P2 with an option to fund the next gaming activity from either native credit or transferred credit. The processor of EGM 2 causes display screen 6 to display: “Press button 12 to use your credit for the next game. Press button 13 to use transferred credit for the next game.” If P2 presses button 12, then the process flow proceeds to step S15 and the gaming activity is executed using P2's native credit. Hence, the processor of EGM 2 decrements the variable representing native credit by the number of credits required for the next gaming activity, which proceeds without any resultant benefit being allocated to EGM 1. The process flow then loops back to S11. On the other hand, if P2 presses button 13, which is what we shall assume for the purposes of the running example, then the process flow proceeds to step S16.

At step S16, P2 operates the buttons 12, 13 and/or 14 so as to place a wager on the upcoming gaming activity. The processor of EGM 2 decrements the variable representing transferred credit by the number of credits required for the next gaming activity. For the sake of the running example we shall assume that the next gaming activity will cost 1 credit and hence the new value of the variable representing transferred credit is 50−1=49 credits.

The process flow now proceeds to step S17 at which the gaming activity is executed on EGM 2 using the transferred credit that was decremented in step S16. For the purposes of the running example, we shall assume that the gaming activity is a slot machine. The processor of EGM 2 executes the slot machine game by causing the screen 6 to display a number of spinning reels that eventually settle into finishing positions, which generates a symbol combination that constitutes the game outcome. Whilst EGM 2 is executing the game, P1 may watch that game proceed in a small window 18 displayed in the corner of EGM 1's screen 5. To achieve this, EGM 2 sends its display signal to EGM 1 via cable 4. EGM 1 receives this signal and re-sizes it for display within window 18. This allows P1 to keep an eye on the game unfolding on EGM 2, whilst simultaneously continuing to engage in gaming activity on EGM 1.

Once the game outcome in finalized, EGM 2's processor determines a player benefit, in the form of a prize amount, in dependence upon the game outcome. In some alternative embodiments, EGM 2's processor firstly determines the desired game outcome, and then displays the spinning reels such that their resting position defines a symbol combination that corresponds to the desired game outcome. In any event, for the game outcomes in which credits are won the process flow proceeds to step S18. However, if the game outcome is not a winning outcome, then the process flow loops back to step S11.

At step S18 the processor of EGM 2 determines the amount of credit that was won, which for the sake of the running example we shall assume is 100 credits. The processor of EGM 2 then multiplies the amount of won credits by the first proportion (which was stored in the RAM of EGM 2 in step S9). In the running example, this calculation is 100*0.35=35. The processor of EGM 2 then sends a message to EGM 1 to indicate that 35 credits are to be allocated from EGM 2 to EGM 1. EGM 2's processor then calculates the remaining amount of won credits, which in the running example is 100−35=65 and the variable representing P2's native credits is incremented by this amount, which in the running example is 10+65=75. Hence, in this example the second proportion, which is the proportion of the benefit that EGM 2 retains, is 65%.

At step S19, EGM 1 receives the message that was sent by EGM 2 in step S18. EGM 1's processor parses the message and extracts the value of 35 credits. This 35 credits represents P1's return for choosing to fund P2's gaming activity. EGM 1's processor then increments the variable representing EGM 1's credit meter by 35. In the running example this is 150+35=185 credits. The process flow now loops back to step S11.

In some embodiments the player benefit takes the form of a points award, which is kept track of in the account that is associated with the player of the EGM. This may be instead of, or in addition to, credits constituting the player benefit. The points are typically redeemable for goods and/or services, for example food, drink and so forth. In some such embodiments points are awarded only when a winning outcome arises. In other such embodiments, points are awarded at the completion of each game, regardless of whether or not the game had a winning outcome. In any event, in some such embodiments, when points are awarded in response to a game that was funded by credits transferred from another EGM, a first proportion of the points is allocated to the EGM from which the credits were transferred and a second proportion of the points is allocated to the EGM that was the recipient of the originally transferred credits.

Various strategies are available for dealing with a situation whereby either P1 or P2 chooses to cash out of their EGM at a point in time when a remaining amount of transferred credits is being stored on EGM 2. Continuing with the running example, we shall assume that P1 decides to cash out of EGM 1 immediately after receiving the above-mentioned allocation of 35 credits. At that point, EGM 1 is storing 185 credits and EGM 2 is storing 75 native credits and a remaining amount of 49 transferred credits. According to one strategy, when P1 makes an input on buttons 9, 10 and/or 11 so as to indicate that he or she wishes to cash out of EGM 1, the processor of EGM causes a message to be sent to EGM 2 requesting the immediate return of the remaining amount of transferred credits that are currently being stored on EGM 2. In response to receipt of this message, the EGM 2's processor accesses the current value of the variable representing transferred credit and sends a message instructing EGM 1 to increment its credit value by that amount. EGM 2 then resets the variable representing transferred credit to zero and displays a message on screen 6 to advise P2 that the player of EGM 1 has requested a return of the remaining transferred credit. Upon receipt of the message, EGM 1 increments its credit value by the amount communicated in the message and displays a message advising P1 that this has occurred. Hence, once the credit transfer has been processed, EGM 1 has 185+49=234 credits, which is cashed out to P1. EGM 2 then has 75 native credits and zero transferred credits. Similarly, if P2 cashes out of EGM 2 at a time when a remaining amount of transferred credit is being stored by EGM 2, and whilst P1 is still playing EGM 1, then the remaining amount of transferred credit is immediately transferred from EGM 2 back to EGM 1.

Another strategy makes use of the accounts associated with the players on the above-mentioned player tracking system. When P1 initially commences use of EGM 1, he or she inputs a card into slot 15. A card reader installed within EGM 1 reads information from the card, which includes an identifier of P1 and details of the account that is associated with P1. In this embodiment, when the initial credit transfer proposal message is sent from EGM 1 to EGM 2 at step S5, it also includes the details of the account that is associated with P1. At step S9, after P2 has accepted the credit transfer proposal, the processor of EGM 2 stores the details of the account that is associated with P1 in EGM 2's RAM. If, P1 chooses to cash out of EGM 1 at a later time when a remaining amount of transferred credit is being stored by EGM 2, then P1 initially only receives the credit that is currently stored on EGM 1. In the running example, this means that P1 would receive 185 credits when cashing out. The 49 transferred credits would remain on EGM 2, thereby allowing P2 to continue to fund gaming activity using the transferred credits even after P1 has cashed out. From this point onwards, the first proportion of any further benefits derived from gaming activity on EGM 2 using the remaining amount of transferred credit is not allocated to EGM 1 (because P1 has vacated that machine). Rather, it is allocated to the account associated with P1. At some point in the future, P1 can access those allocated credits via the account that is associated with P1. In other words, P1 can cash out of EGM 1 and, if he or she so chooses, P1 can leave the gaming establishment altogether, whilst P2 continues to use the transferred credits on EGM 2. P1 can then return to the gaming establishment at a later time and access those allocated credits from P1's player account. Similarly, if P2 cashes out of EGM 2 at a time when a remaining amount of transferred credit is being stored by EGM 2, and after P1 has cashed out of EGM 1, then the remaining amount of transferred credit at the time P2 cashes out is allocated to the account associated with P1.

In some embodiments of the invention a house commission is charged whenever credits are transferred from one EGM to another. In one such embodiment, a flat fee of 1 credit is deducted each time credit is transferred. Hence, if 50 credits are transferred from EGM 1 to EGM 2, then the credit stored on EGM 1 is decremented by the full 50 credits, however the variable representing transferred credits as stored on EGM 2 is only incremented by 49 credits. This commission is effectively a charge for making use of the credit transferal process.

An embodiment having a plurality of EGM's connected to a central controller 20 is shown in FIG. 2. The controller 20 has a central processing unit (CPU) and a communications card that is operatively coupled to the CPU and which communicatively links the controller 20 to the plurality of electronic gaming machines (EGM's) 21, 22, 23, 24 and 25. In some embodiments the communications link 26 is provided by cables, a wireless link, a local area network, a wide area network, or a combination thereof. The EGM's 21, 22, 23, 24 and 25 may be located within a single establishment, or may be located in two or more geographically dispersed locations. Also operatively coupled to the CPU is controller memory, which is typically in the form of random access memory (RAM) and/or other readable and writable digital storage media such as hard drives, flash drives, and the like.

In the embodiment illustrated in FIG. 2 each of the EGM's 21, 22, 23, 24 and 25 are communicatively interlinked with each of the other EGM's 21, 22, 23, 24 and 25, with all communications being routed via the controller 20. Hence, for example, it is possible for each of the EGMs to send a digitally encoded message that is intended for another of the EGM's to the controller 20. The controller 20 then parses the message to determine the intended EGM recipient and effectively forwards the message onto that EGM. However, other embodiments dispense with the requirement for the controller 20 to act as a communications intermediary. In one such embodiment, each of the EGM's is communicatively linked directly to each of the other EGM's. In another such embodiment, each of the EGM's is communicatively linked to each of the other EGM's via a known networking communications architecture, such as daisy chain arrangement, for example. The important thing so far as embodiments of the present invention are concerned is that the EGM's are communicatively linked with each other.

In some embodiments the CPU of the controller 20 is programmed to perform the inventive method by means of computer executable code stored on a computer readable medium, such as a CD-ROM, for example. In other embodiments the executable code is accessed either by means of downloading a file from a remote location, for example via the internet, or by means of remote execution, such as in a so-called “cloud computing” context.

In some embodiments it is the central controller 20 that keeps track of the native and transferred credit values for each of the EGM's 21, 22, 23, 24 and 25. The central controller also monitors the awarding of player benefits and updates the values of the various credit meters so as to allocate the first proportion to the EGM that funded the gaming activity and so as to allocate the second proportion to the EGM upon which the gaming activity was executed.

In the embodiment illustrated in FIG. 2, the player of one of the EGM's may provide an input via the input module to cause that EGM to send credit transfer proposal messages to some or all of the other EGM's within said plurality of EGM's. For example, the player of EGM 21 may provide an input causing his or her EGM 21 to send a message to all of the other EGMs 22, 23, 24 and 25 proposing to transfer, say, 100 credits to each of them. This proposal may be accepted or declined by each of the players at each of the other EGM's 22, 23, 24 and 25 in the manner described in detail above.

While a number of preferred embodiments have been described, it will be appreciated by persons skilled in the art that numerous variations and/or modifications may be made to the invention without departing from the spirit or scope of the invention as broadly described. The present embodiments are, therefore, to be considered in all respects as illustrative and not restrictive.

1. A gaming apparatus including:
a first electronic gaming machine (EGM) communicatively interlinked to a second EGM;
the first and second EGM's each being configured so as to store respective credit values;
the first EGM having a player operable input module for causing the first EGM to send a credit transfer proposal message to the second EGM;
the second EGM being responsive to receipt of the credit transfer proposal message so as to provide a player of the second EGM with an option to accept or decline the proposal;
the first and second EGM's being responsive to an acceptance of the proposal so as to transfer credit from the first EGM to the second EGM; and
the second EGM being operable so as to execute gaming activity using transferred credit and, if said gaming activity generates a player benefit, a first proportion of the benefit is allocated to the first EGM and a second proportion of the benefit is allocated to the second EGM.

2. A gaming apparatus according to claim 1 wherein the gaming activity is the placement of a wager using said transferred credit, the generation of a game outcome and the determination of a prize amount in dependence upon the game outcome and wherein the benefit is the prize amount.

3. A gaming apparatus according to claim 1 wherein the benefit is, or includes, a points award.

4. A gaming apparatus according to claim 1 wherein the credit transfer proposal message defines an amount of credit that is proposed to be transferred.

5. A gaming apparatus according to claim 1 wherein the second EGM is configured so as to store a native credit value and a transferred credit value.

6. A gaming apparatus according to claim 5 wherein the second EGM is configured to provide the player of the second EGM with an option to place a wager using either native credit or transferred credit.

7. A gaming apparatus according to claim 1 wherein the first proportion is between 10% and 50%.

8. A gaming apparatus according to claim 1 wherein the first EGM is configured to receive an input from the player operable input module so as to allow a player of the first EGM to define the first proportion.

9. A gaming apparatus according to claim 8 wherein the credit transfer proposal message includes an amount of credit that is proposed to be transferred and the first proportion.

10. A gaming apparatus according to claim 9 wherein the provision to the player of the second EGM of an option to accept or decline the proposal includes advising the player of the second EGM of an amount of credit that is proposed to be transferred and advising the player of the second EGM of the first proportion.

11. A gaming apparatus according to claim 1 wherein, if a player of the first EGM cashes out of the first EGM at a time when a remaining amount of transferred credit is being stored by the second EGM, then the remaining amount of transferred credit is transferred back to the first EGM and cashed out to the player of the first EGM.

12. A gaming apparatus according to claim 1 wherein the first EGM is adapted to receive an identifier of a player of the first EGM and to access information stored within an account associated with the player of the first EGM.

13. A gaming apparatus according to claim 12 wherein, if a player of the first EGM cashes out of the first EGM at a time when a remaining amount of transferred credit is being stored by the second EGM, then the remaining amount of transferred credit remains on the second EGM and the first proportion of any further benefits derived from gaming activity on the second EGM using the remaining amount of transferred credit is allocated to the account associated with the player of the first EGM.

14. A gaming apparatus according to claim 1 wherein if a player of the second EGM cashes out of the second EGM at a time when a remaining amount of transferred credit is being stored by the second EGM, and whilst the player of the first EGM is still playing the first EGM, then the remaining amount of transferred credit is transferred back to the first EGM.

15. A gaming apparatus according to claim 12 wherein if a player of the second EGM cashes out of the second EGM at a time when a remaining amount of transferred credit is being stored by the second EGM, and after the player of the first EGM has cashed out of the first EGM, then the remaining amount of transferred credit is allocated to the account associated with the player of the first EGM.

16. A gaming apparatus according to claim 1 wherein a house commission is charged when credits are transferred from one EGM to another.

17. A gaming apparatus according to claim 1 wherein a plurality of EGM's are communicatively interconnected and wherein the player operable input module of the first EGM is operable to cause the first EGM to send credit transfer proposal messages to some or all of the other EGM's within said plurality of EGM's.

18. A gaming apparatus according to claim 1 wherein the first and second EGM's each have display screens and, whilst the second EGM is executing said gaming activity using transferred credit, an image corresponding to an image on the display screen of the second EGM is depicted on the display screen of the first EGM.

19. A gaming method implementable on a first electronic gaming machine (EGM) communicatively interlinked to a second EGM, the method including:
storing credit values in each of the first and second EGM's;
being responsive to a player input on the first EGM so as to send a credit transfer proposal message from the first EGM to the second EGM;
being responsive to receipt of the credit transfer proposal message so as to provide a player of the second EGM with an option to accept or decline the proposal;
being responsive to an acceptance of the proposal so as to transfer credit from the first EGM to the second EGM; and
executing gaming activity on the second EGM using transferred credit and, if said gaming activity generates a player benefit, allocating a first proportion of the benefit to the first EGM and allocating a second proportion of the benefit to the second EGM.

20. A gaming method according to claim 19 wherein the first EGM is communicatively interlinked to the second EGM via a central controller.
